(19) United States
(12) Patent Application Publication
(10) Pub. No.: US 2006/0092890 A1
(43) Pub. Date: May 4, 2006

(54) Global network neighborhood: scheme for providing information about available networks in a geographical location

(76) Inventors: Vivek G. Gupta, Portland, OR (US); David Johnston, Beaverton, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/979,551

(22) Filed: Nov. 1, 2004

(51) Int. Cl. H04Q 7/24

(52) U.S. Cl. 370/338

(57) ABSTRACT

A method and apparatus supporting a discovery technique of multiple available networks is disclosed. A global network neighborhood data depository contains attributes of multiple networks that are available in a geographic region. The attributes aid in network discovery and selection of an optimum network for communication for devices capable of communicating via multiple networks.

### BACKGROUND

Description of the Related Art

In advancing communication technology, a single device may be able to communicate over two or more different kinds of wired or wireless links. Each of these links may implement a different link protocol, and distinct types of hardware and software may be used to support the various protocols. The networks formed by the different types of links may be heterogeneous networks, meaning that the hardware and software associated with one of the links might not be usable to make connections across another link. Some of the networks formed by the different types of links may be homogeneous links, but may have different access parameters, including operator or carrier differences, access point or base station differences, encoding differences, and the like.

A given locality, for example, a large campus in a school or enterprise, may support multiple wired and wireless networks. Network discovery is an important issue for a mobile device capable of communicating via multiple networks. The mobile device can perform an exhaustive scan to determine available networks in the given locality prior to selecting an optimum network for communication. However, this scan can include sequential media sensing for all possible networks which can be time consuming and power draining. A better technique for network discovery to aid in appropriate network selection is needed.

### BRIEF DESCRIPTION OF THE DRAWINGS

The present invention may be better understood, and its numerous features and advantages made apparent to those skilled in the art by referencing the accompanying drawings.

FIG. 1 illustrates a block diagram of a communication system with multiple wired and wireless networks according to an embodiment of the present invention.

FIG. 2 illustrates a global network neighborhood data repository according to an embodiment of the present invention.

FIG. 3 illustrates a flow diagram performed by a device according to an embodiment of the present invention.

FIG. 4 illustrates a flow diagram for accessing a global network neighborhood data repository according to an embodiment of the present invention.

The use of the same reference symbols in different drawings indicates similar or identical items.

### DESCRIPTION OF THE EMBODIMENT(S)

In the following description, numerous specific details are set forth. However, it is understood that embodiments of the invention may be practiced without these specific details. In other instances, well-known methods, structures and techniques have not been shown in detail in order not to obscure an understanding of this description.

References to “one embodiment,” “an embodiment,” “example embodiment,” “various embodiments,” and the like, indicate that the embodiment(s) of the invention so described may include a particular feature, structure, or characteristic, but not every embodiment necessarily includes the particular feature, structure, or characteristic. Further, repeated use of the phrase “in one embodiment” does not necessarily refer to the same embodiment, although it may.

As used herein, unless otherwise specified the use of the ordinal adjectives “first,” “second,” “third,” and the like, to describe a common object, merely indicate that different instances of like objects are being referred to, and are not intended to imply that the objects so described must be in a given sequence, either temporally, spatially, in ranking, or in any other manner.

Unless specifically stated otherwise, as apparent from the following discussions, it is appreciated that throughout the specification discussions utilizing terms such as “processing,” “computing,” “calculating,” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data from registers and/or memory to transform that electronic data into other electronic data that may be stored in registers and/or memory. A “computing platform” may comprise one or more processors.

Types of communication systems intended to be within the scope of the present invention include, although not limited to, Local Area Network (LAN), Ethernet, Wireless Local Area Network (WLAN), Wireless Wide Area Network (WWAN), Wireless Personal Area Network (WPAN), Wireless Metropolitan Area Network (WMAN), Code Division Multiple Access (CDMA) cellular radiotelephone communication systems, Global System for Mobile Communications (GSM) cellular radiotelephone systems, North American Digital Cellular (NADC) cellular radiotelephone systems, Time Division Multiple Access (TDMA) systems, Extended-TDMA (E-TDMA) cellular radiotelephone systems, third generation (3G) systems like Wide-band CDMA (WCDMA), CDMA-2000, Universal Mobile Telecommunications System (UMTS), and the like, although the scope of the invention is not limited in this respect.

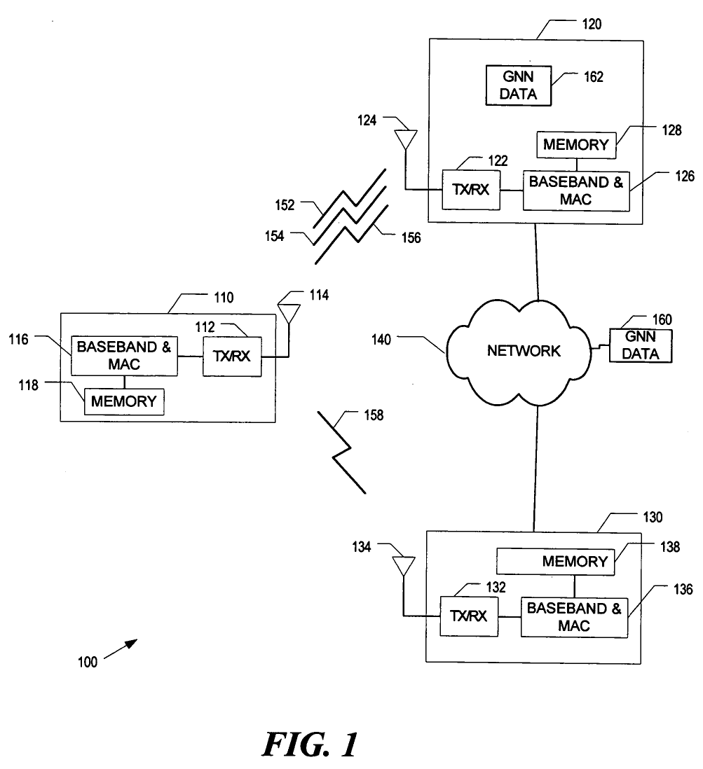

FIG. 1 illustrates a block diagram of a communication system with multiple wired and wireless networks according to an embodiment of the present invention. In the system 100 shown in FIG. 1, a first device 110 may include a wireless transceiver 112 to couple to one or more antennas 114 and to a baseband processor 116. Baseband processor 116 in one embodiment may include a single processor, or alternatively may include a baseband processor and an applications processor, although the scope of the invention is not limited in this respect. Baseband processor 116 may couple to a memory 118 which may include volatile memory such as DRAM, non-volatile memory such as flash memory, or alternatively may include other types of storage such as a hard disk drive, although the scope of the invention is not limited in this respect. Some portion or all of memory 118 may be included on the same integrated circuit as baseband processor 116, or alternatively some portion or all of memory 118 may be disposed on an integrated circuit or other medium, for example a hard disk drive, that is external to the integrated circuit of baseband processor 116, although the scope of the invention is not limited in this respect.

First device 110 communicates to a second device 120 and a third device 130, at least one of the three may be a mobile unit (MU). Second device 120 may include a transceiver 122, one or more antennas 124, baseband processor 126, and memory 128. Third device 130 may include a transceiver 132, one or more antennas 134, baseband processor 136, and memory 138.

First device 110, second device 120, and third device 130 may be any of various devices, such as a cellular telephone, wireless telephone headset, printer, wireless keyboard, mouse, wireless network interface devices and network interface cards (NICs), base stations, access points (APs), gateways, bridges, hubs, cellular radiotelephone communication systems, satellite communication systems, two-way radio communication systems, one-way pagers, two-way pagers, personal communication systems (PCS), portable or stationary personal computers (PCs), personal digital assistants (PDAs), software defined radios, reconfigurable radios, or other device capable of communicating over a wireless network. Additionally or alternatively, in other embodiments of the present invention, communication system 100 may include additional devices, any of which may be mobile units.

In some embodiments, first device 110, second device 120, and third device 130 may transmit and/or receive one or more packets over system 100 via antennas 114, 124, and 134. In addition, first device 110, second device 120, and third device 130 may include two or more antennas to provide a diversity antenna arrangement, to provide spatial division multiple access (SDMA), or to provide a multiple input, multiple output (MIMO) system, or the like, although the scope of the invention is not limited in this respect. The packets may include data, control messages, network information, and the like.

Second device 120 may be coupled with network 140 wired or wirelessly so that first device 110 and second device 120 may communicate with network 140, including devices coupled to network 140. Network 140 may include a public network such as a telephone network or the Internet, or alternatively network 140 may include a private network such as an intranet, or a combination of a public and a private network, although the scope of the invention is not limited in this respect. Third device 130 may also couple with network 140. Second device 120 and/or third device 130 may be network attachment points, for example, access points, base stations, and the like, though the invention is not limited in this respect. For example, second device 120 and/or third device 130 may be other wired or wireless devices with indirect network access.

First device 110 and second device 120 may communicate with each other via one of multiple wireless communication links, for example links 152, 154, and 156. First device 110 and third device 130 may communicate with each other via wireless communication link 158. Each of these links may implement a different wireless air link protocol, and distinct types of hardware and software may be used to support the various protocols. For example, transceiver 112 and antennas 114 may include multiple transceivers and antennas for communicating via the multiple wireless communication links. The choice of which communication link to use may be determined based on proximity to the other device, strength of a signal, available bandwidth, cost of wireless spectrum, user or system level policies, and other such conditions.

Note that first device 110 is illustrated as being capable of communicating according to three or more wireless networks, second device 120 is illustrated as being capable of communicating according to three wireless networks and a wired network (to network 140), and third device 130 is illustrated as being capable of communicating according to one wireless network and a wired network. Each device may be capable of communicating according to any number of wired or wireless networks, the invention is not limited in this scope.

Links 152, 154, 156, and 158 may be implemented in accordance with various wireless standards including, for example, one or more wireless cellular standards, one or more wireless networking standards, one or more radio frequency identification (RFID) standards, and/or others. Some of the different networks formed by links 152, 154, 156, and 158 may be heterogeneous networks, meaning that the hardware and software associated with one of the links cannot typically be used to make connections across another link. In at least one implementation, for example, at least one link is implemented in accordance with the Bluetooth short range wireless protocol (Specification of the Bluetooth System, Version 1.2, Bluetooth SIG, Inc., November 2003, and related specifications and protocols). Other possible wireless networking standards include, for example: IEEE 802.3, IEEE 802.11 (ANSI/IEEE Std 802.11-1999 Edition and related standards), IEEE 802.16, HIPERLAN 1, 2 and related standards developed by the European Telecommunications Standards Institute (ETSI) Broadband Radio Access Networks (BRAN), HomeRF (HomeRF Specification, Revision 2.01, The HomeRF Technical Committee, July, 2002 and related specifications), and/or others. Some of the different networks formed by links 152, 154, 156, and 158 may be homogeneous links, but may have different access parameters, including operator or carrier differences, access point or base station differences, encoding differences, and the like. For example, networks formed by links 156 and 158 may be IEEE 802.11 networks but have different access parameters, for example, as two different access points and/or two different operators/carriers.

In one embodiment of the present invention, first device 110 communicates with second device 120 via wireless link 152. If the communication environment changes, for example, if first device 110 is a mobile device and begins moving out of a range capable of communicating via link 152, first device 110 may begin communicating, for example, with second device 120 via link 154 or with third device 130 via link 158.

As illustrated, first device 110 has multiple choices of communication networks, for example, via one of links 152, 154, 156, and 158. The discovery of each communication network and selection of an available network is aided by global network neighborhood data 160 accessible via network 140 and/or global network neighborhood data 162 stored on second device 120. Global network neighborhood data 160, 162 include information about wireless networks in the local area. Note that global network neighborhood data 160 may return different data than global network neighborhood data 162 due to, for example, different geography, different carrier supplied information, and other reasons. First device 110 may request information regarding currently available wired and wireless networks in its vicinity. Using information from global network neighborhood data 160 or 162, first device 110 can select a network according to pre-defined user preferences and communicate according to the selected network's policies.

Global network neighborhood data 160 can be retrieved using any network with access to network 140. For example, using an 802.11 WLAN radio link, for example, link 158, first device 110 may retrieve information from global network neighborhood data 160 about available 802.16, GSM and WCDMA networks in the vicinity. Similarly, using an 802.16 radio link, for example, link 156, first device 110 may retrieve information from global network neighborhood data 162 about multiple available wireless networks in the vicinity. The retrieved information may include details of each network, for example, type of network, radio frequency (RF) link layer connection parameters, security information, type of physical layer, operator or carrier policy information, a list and location of access points (APs) or base stations, and the like. Information about available networks may be obtained using any network, eliminating the need to power up each wireless transceiver and perform sequential media sensing to gather information about currently available networks in a given locality.

In one embodiment, a device with a wired connection, for example third device 130 with a wired connection to network 140 may request information from global network neighborhood data 160 and determine that an available wireless connection to network 140 may be more optimum, for example, if the wired connection includes a user charge and the wireless connection is cheaper.

In another embodiment, a device with a wireless connection, for example first device 110 with a 802.11 network via link 156 may request information from global network neighborhood data 162 and determine that another 802.11 network via link 158 may be more optimum, for example, if the new network has more available bandwidth.

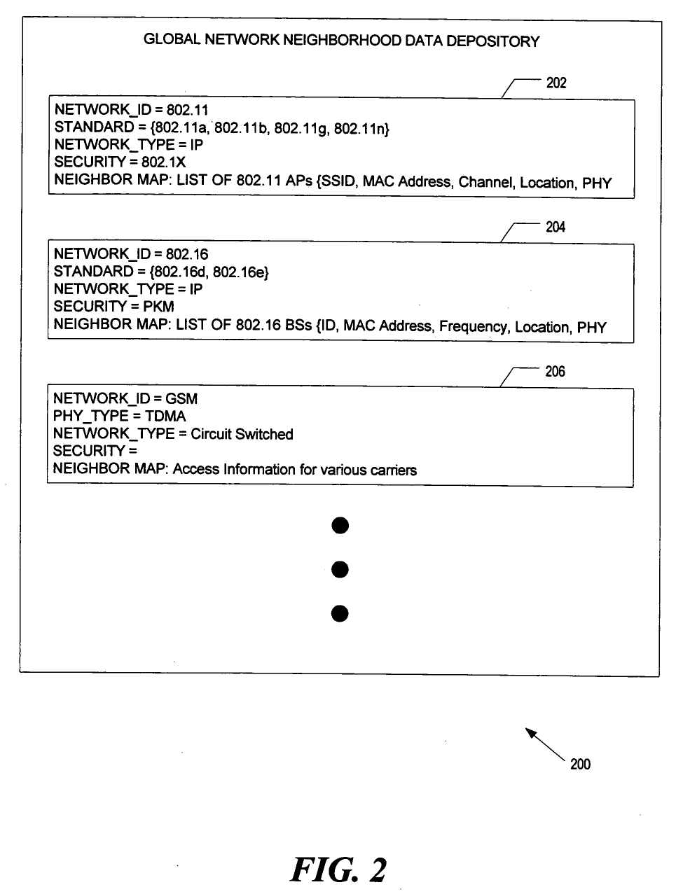

FIG. 2 illustrates a global network neighborhood data repository according to an embodiment of the present invention. Global network neighborhood data repository 200 includes details about multiple networks to aid in network communication and selection. For example, global network neighborhood data repository 200 includes an element 202 detailing an 802.11 network, an element 204 detailing an 802.16 network, an element 206 detailing a GSM network, and the like. Each element may contain network details such as supported standard and version, network type, RF link level information, operator and carrier policy, security information, neighbor mapping information such as base station or access point identification and location, and the like. By accessing data repository 200 using a location identifier, information about currently available networks in the given location can be obtained.

The elements contained in global network neighborhood data repository 200 may be represented in a globally accepted format such as ASN.1, represented below.

Network_List ::= ENUMERATED {802.11, 802.16, GSM,
GPRS, W-CDMA, cdma2000}
802.11 ::= SEQUENCE{

Standards ::= ENUMERATED {802.11a, 802.11b, 802.11g}
Security ::= ENUMERATED {802.1x, WPA, WPA2, WEP, open,
MAC Address}
802.1x_WPA_WPA2 ::= ENUMERATED {EAP-PEAP-
MSCHAPv2, EAP-TTLS-PAP, EAP-TTLS-CHAP, EAP-TLS, EAP-
SIM, EAP-AKA}*
SSID_Network_Name ::= String (SIZE(1..32))
BSSID ::= NumericString (SIZE(8))
Channel ::= INTEGER
Phy ::= ENUMERATED {CCK, DSSS, OFDM}
Connection_Type ::= ENUMERATED {Packet-Switched}
Data_Rates ::= INTEGER
Service_Provider ::= String
Region ::= String
Country ::= String
Quality_of_Service ::= Boolean
Location_LatLong ::= REAL
}

GSM ::= SEQUENCE {

Ciphering ::= ENUMERATED {A3/A8, A5/1, A5/2}
Frequency_Band ::= ENUMERATED {900, 1800, 1900}
Operator_Network_Code_MNC ::= INTEGER
Operator_Country_Code_MCC ::= INTEGER
Location_Area_Code_LAC ::= INTEGER
Cell_Identity_CID ::= INTEGER
BSIC ::= INTEGER
Serving_Cell_Channel ::= REAL
Connection_Type ::= ENUMERATED {Circuit-Switched}
+Location_LatLong ::= REAL

}
GPRS ::= SEQUENCE {

Ciphering ::= ENUMERATED {A3/A8, A5/1, A5/2, A5/0}
Frequency_Band ::= ENUMERATED {900, 1800, 1900}
Operator_Network_Code_MNC ::= INTEGER
Operator_Country_Code_MCC ::= INTEGER
Location_Area_Code_LAC ::= INTEGER
Routing_Area_Code_RAC ::= INTEGER
Cell_Identity_CID ::= INTEGER
BSIC ::= INTEGER
Serving_Cell_Channel ::= REAL
Coding_Scheme ::= ENUMERATED {CS-1, CS-2, CS-3, CS-4}
Multislot_Classes ::= ENUMERATED {1..29}
APN ::= REAL
Quality_of_Service ::= BEST EFFORT
Connection_Type ::= ENUMERATED {Packet-Switched}
+Location_LatLong_GPRS ::= REAL

}

The above ASN.1 encoded elements provide an example of types of information that may be included in each element of global network neighborhood data repository 200. Any information may be included, for example, that aids in network communication and selection. Further, elements describing types of networks other than those illustrated above may be included, the scope of the invention is not intended to be limited in this respect.

In one embodiment, global network neighborhood data repository 200 is stored on a server connected to network 140 and is maintained by a service provider. For example, a service provider may operate WiFi, WiMAX, and GSM networks in a given locality. By accessing the service provider's server with a location identifier, data regarding currently available networks in the given location can be downloaded to first device 110.

In another embodiment, global network neighborhood data repository 200 is stored on an access point or base station, for example, second device 120. Second device 120 may maintain its own data, for example, by occasionally scanning the wireless medium for available networks, polling other devices for information, or occasionally downloading information from a server.

The information included in global network neighborhood data repository 200 may be static as well as dynamic. For example, the information may include static information such as a list of access points in the network that was pre-entered administratively in a database. An access point, for example, second device 120 may load the information from global network neighborhood data repository 200 upon power up. The initial information obtained may not be updated to reflect the latest accurate information of available access points in the network at a certain point in time, as some access points may be powered off due to hardware failure or administrative maintenance.

The information included in global network neighborhood data repository 200 may be dynamic, for example, updated by an access point that occasionally scans the wireless medium for available networks, polls other devices for information, or occasionally downloads information from a server. The information may be collated within a certain boundary. The updated information can be temporarily stored at the access point or handset or uploaded to global network neighborhood data repository 200 for further collation with similar updates from other access points and handsets in the network in order to obtain a map of the global network neighborhood.

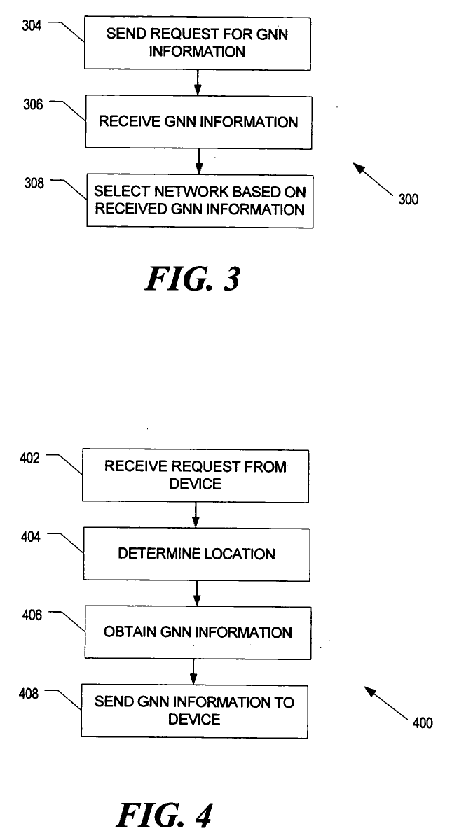

FIG. 3 illustrates a flow diagram performed by a device according to an embodiment of the present invention. A device capable of communicating via multiple networks sends a request for global network neighborhood information, block 304.

In a first embodiment, upon power up, first device 110 selects a default communication link, for example, link 158 to initiate communication. Alternatively, first device 110 may be communicating via link 158 and detect a change in environment and need to switch communication networks. First device 110 requests information regarding available networks for communication. Third device 130 accesses a depository of global network neighborhood data 160 via network 140. First device 110 may include location information with the request. Alternatively, third device 130 may be aware of the location of first device 110 and attach a location identifier to the request or attach its own location identifier to the request. In another embodiment, first device 110 may request global network neighborhood data from second device 120. Second device 120 may have its own global network neighborhood data 162.

In one embodiment of the present invention, the request may include a selective query to obtain detailed information about a few select wired or wireless networks, for example, according to the requesting device's communication capabilities, reducing the time required for network discovery and selection and reducing the amount of information to be processed.

The device receives the global network neighborhood information, block 306, and selects a network on which to communicate based on the global network neighborhood information received, block 308. Selection of a communication network may also be based on a set of pre-defined policies such as, for example, user preference of network type (for example, based on charges, power consumption, throughput, and the like); and physical parameters such as link quality (signal strength, signal-to-noise ratio), load balancing, and the like.

FIG. 4 illustrates a flow diagram for accessing a global network neighborhood data repository according to an embodiment of the present invention. A base station or access point receives a request for global network neighborhood information from a device, block 402. The base station determines location information, block 404. For example, the device may send location information with the request. Alternatively, the base station determines the location of the device or uses its own location. The base station obtains global network neighborhood information based on the location information, block 406. In one embodiment, the base station accesses a global network neighborhood database, for example, through a network or stored on the base station. The base station sends the global network neighborhood information to the device, block 408.

The techniques described above may be embodied in a computer-readable medium for configuring a computing system to execute the method. The computer readable media may be permanently, in a removable manner, or remotely coupled to first device 110, second device 120, or another system. The computer readable media may include, for example and without limitation, any number of the following: magnetic storage media including disk and tape storage media; optical storage media such as compact disk media (for example, CD-ROM, CD-R, and the like) and digital video disk storage media; holographic memory; nonvolatile memory storage media including semiconductor-based memory units such as FLASH memory, EEPROM, EPROM, ROM; ferromagnetic digital memories; volatile storage media including registers, buffers or caches, main memory, RAM, and the like; and data transmission media including permanent and intermittent computer networks, point-to-point telecommunication equipment, carrier wave transmission media, the Internet, just to name a few. Other new and various types of computer-readable media may be used to store and/or transmit the software modules discussed herein. Computing systems may be found in many forms including but not limited to mainframes, minicomputers, servers, workstations, personal computers, notepads, personal digital assistants, various wireless devices and embedded systems, just to name a few. A typical computing system includes at least one processing unit, associated memory and a number of input/output (I/O) devices. A computing system processes information according to a program and produces resultant output information via I/O devices.

Realizations in accordance with the present invention have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the various configurations may be implemented as a combined structure or component. These and other variations, modifications, additions, and improvements may fall within the scope of the invention as defined in the claims that follow.

What is claimed is:

1. A method comprising:
receiving information regarding multiple available networks in a given locality from a data repository; and
selecting one of the multiple available networks for communication.

2. The method as recited in claim 1, wherein the information includes network specific details for communication with each of the multiple available networks.

3. The method as recited in claim 1, wherein the information includes network specific details to aid in selection of one of the multiple available networks.

4. The method as recited in claim 1, further comprising sending a request for the information, wherein the request includes a location identifier.

5. The method as recited in claim 5, wherein the location identifier is used to select a subset of elements in the data repository.

6. The method as recited in claim 1, further comprising sending a request for the information, wherein the request includes a selective query to obtain detailed information about a few select networks.

7. The method as recited in claim 1, wherein the data repository is service provider generated.

8. The method as recited in claim 1, wherein the data repository is updated as a result of network sensing scans.

9. The method as recited in claim 1, wherein the selecting is further based on predefined user preferences.

10. The method as recited in claim 1, wherein the receiving and the selecting occur during power up of a device.

11. The method as recited in claim 1, wherein the receiving and selecting occur during handoff between a first network and a second network.

12. The method as recited in claim 12, wherein the first network and the second network are heterogeneous networks.

13. The method as recited in claim 12, wherein the first network and the second network are homogeneous networks.

14. The method as recited in claim 1, wherein the multiple available networks include more than one type of wireless network.

15. An apparatus comprising:
a transceiver capable of communicating via a plurality of links; and

16. a baseband processor to receive information regarding multiple available networks in a given locality from a data repository, and to select one of the multiple available networks for communication based on the information.

17. The apparatus as recited in claim 15, wherein the information includes network specific details for communication with each of the multiple available networks.

18. The apparatus as recited in claim 15, wherein the information includes network specific details to aid in selection of one of the multiple available networks.

19. The apparatus as recited in claim 15, the baseband processor further to send a request for the information, wherein the request includes a location identifier.

20. The apparatus as recited in claim 18, wherein the location identifier is used to select a subset of information in the data repository.

21. The apparatus as recited in claim 15, the baseband processor further to send a request for the information, wherein the request includes a selective query to obtain detailed information about a few select networks.

22. The apparatus as recited in claim 15, wherein the data repository is service provider generated.

23. The apparatus as recited in claim 15, wherein the data repository is updated as a result of network sensing scans.

24. The apparatus as recited in claim 15, wherein receipt of information and selection of the network occurs during power up of the apparatus.

25. The apparatus as recited in claim 15, wherein receipt of information and selection of the network occurs during handoff between a first network and a second network.

26. The apparatus as recited in claim 24 wherein the first network and the second network are heterogeneous networks.

27. The apparatus as recited in claim 24, wherein the first network and the second network are homogeneous networks.

28. The apparatus as recited in claim 15, wherein the multiple available networks include more than one type of network.

29. A communication device comprising:
one or more antennas to communicate to a wireless network via a wireless link;
a transceiver capable of communicating to a plurality of networks including the wireless network; and

30. a baseband processor to receive information regarding multiple available networks in a given locality from a data repository, and to select one of the multiple available networks for communication.

31. The communication device as recited in claim 28, wherein the information includes network specific details for communication with each of the multiple available networks.

32. The communication device as recited in claim 28, wherein the information includes network specific details to aid in selection of one of the multiple available networks.

33. The communication device as recited in claim 28, the baseband processor further to send a request for the information, wherein the request includes a location identifier.

34. The communication device as recited in claim 31, wherein the location identifier is used to select a subset of information in the data repository.

35. The communication device as recited in claim 31, wherein the multiple available networks include more than one type of network.

36. A depository of information comprising:

37. a plurality of elements, each of the plurality of elements containing details of a different network, and each element including location information to aid in selection of a subset of the plurality of elements.

38. The depository of information as recited in claim 34, wherein the details include network specific details for communication with the different network.

39. The depository of information as recited in claim 34, wherein a location identifier is used to select a subset of the plurality of elements.

40. The depository of information as recited in claim 34, wherein the depository is service provider generated.

41. The depository of information as recited in claim 34, wherein the depository is updated as a result of network sensing scans.

42. A method comprising:
receiving a request for information regarding multiple available networks in a given locality; and

43. sending a plurality of elements; each of the plurality of elements containing details of a different network.

44. The method as recited in claim 39, wherein each of the plurality of elements includes network specific details for communication with one of the multiple available networks.

45. The method as recited in claim 39, wherein each of the plurality of elements includes network specific details to aid in selection of one of the multiple available networks.

46. The method as recited in claim 39, wherein the request includes a location identifier.

47. The method as recited in claim 42, wherein the location identifier is used to select the plurality of data elements.

48. The method as recited in claim 39, wherein the request includes a selective query to obtain detailed information about a few select networks.
